(19) United States
(12) Patent Application Publication
(10) Pub. No.: US 2009/0150259 A1
(43) Pub. Date: Jun. 11, 2009

(54) Collection of Magazine Articles

(76) Inventor: Arjun Yetukuri, Rochester Hills, MI (US)

Correspondence Address: THOUGHT WAVES INC., 194 SANDALWOOD DR., ROCHESTER HILLS, MI, 48307, US

(21) Appl. No.: 12/267,557

(22) Filed: Nov. 7, 2008

Related U.S. Application Data
(60) Provisional application No. 61/012,433, filed on Dec. 9, 2007.

(51) Int. Cl. G06Q 30/00; G06Q 50/00

(52) U.S. Cl. 705/27; 705/26

(57) ABSTRACT

A method of doing business of creating a collection of magazine articles selectively collected from multiple magazines and converted to audio mode is disclosed. Several magazines are available for specific areas of interest. However, all articles in all magazines may not be of interest to all readers. So, if a reader wanted to read all the articles related to a particular topic from multiple magazines, the reader, currently, has to get all those magazines from a library or purchase them. The current invention supports the demand and interest for audio versions and solves two potential customer problems: lack of enough time to read multiple magazines and cost incurred by the customer in purchasing several magazines for all articles of interest. So, the customers who are interested in multiple articles from multiple magazines can receive them as a collection of articles or in other words, a personalized magazine in audio mode.

### CROSS-REFERENCE TO RELATED APPLICATION

This application claims the benefit of U.S. Provisional Application No. 61012433 filed on Dec. 9, 2007, which is hereby incorporated by reference in its entirety.

### BACKGROUND

1. Field of the Invention

Current invention relates to a method of doing business of creating a collection of magazine articles selectively collected from multiple magazines and converted to audio mode. Alternately, this invention also relates to method of doing business of selectively collecting articles from multiple magazines and creating a collection of articles in readable mode. The source of the articles can be either published printed magazines or material intended for publication. The conversion to audio mode can be recorded voice of amateurs or professional readers or with a text to audio conversion software.

2. Description of Related Art

Numerous magazines are produced and sold on a weekly and monthly basis. New magazines are designed and developed on a regular basis to cater to ever changing tastes of readers and market trends. Several magazines are available for specific areas of interest; sports, news, politics, health, music, celebrity lives, gossip, home improvements, technology are just a few dedicated areas that several magazines are published to cover. Multiple age groups, demography, and professions are also categories that several magazines are designed to cater to.

Reading magazines is of interest and a favorite pass time for a lot of people. Printed magazines are read at home, libraries, book stores, reception or waiting areas, offices, and on public transportation. Electronic magazines are read online on the internet or read as e-books using specific hardware and software. Magazines are read for a variety of reasons such as for recreation, for gaining knowledge, to find solutions, and to understand the political issues. Magazines are read by adults, youth, and children. Magazines, depending on the content, are read to adults who cannot read for themselves and to children who have not learned to read yet.

There has been significant success in producing audio versions of books. Either fiction or non-fiction books, audio books, commonly referred to as books on tape have been widely popular. Organizations such as Talking Books have numerous titles on audio tapes or more recently on CDs.

As mentioned earlier, technological advances have introduced new ways of making books and magazines available to people. Examples of such innovations are internet and electronic books, commonly referred to as e-books. Several magazines and books are available online. People use a variety of gadgets to access these online versions of magazines and books. Alternately, electronic versions of books and magazines are also available. E-books may require specific hardware and software to access and read a desired book or magazine.

Apart from accessing magazines and books online, multiple methods of transferring these electronic versions of books and magazines have been developed. Examples of such technologies are e-mail, download, streaming, podcasting, auto-casting, and audio blogging. Audible.com is a successful website where numerous books are available in audio mode. Also available at audible.com are audio versions of private material. Peachpit Press is also another successful publisher that offers on their website several e-books. There are also magazines that are only available online.

As people's lives become hectic and as more technological advances take place, people tend to accomplish more tasks in lesser time. Positively speaking, in other words, there is a tendency to be more efficient. On the other hand, as people become more ambitious in their goals in their attempts to accomplish more tasks, prioritization of tasks occurs and among other things, reading a book or a magazine may drop down on the priority list. There may be lesser time available to read.

With the advent of above mentioned technologies books and magazines are more accessible and knowledge acquisition is more feasible. However, the current approaches suffer from one deficiency. Current publishers of magazines offer either printed or online electronic magazines in part or in entirety from one source at a time.

As mentioned earlier, people with their hectic lives, look for ways to use their time efficiently to accomplish more including reading magazines, may it be to quench their thirst for knowledge or for recreation. People wanting to read a magazine may not necessarily find time to read all the articles of interest from multiple magazines, or all the articles in one magazine, or peruse through all magazines of interest.

As in any business model or a situation, cost and time play a significant role. To read, for example, 5 articles that are scattered over 5 different magazines, the customer will have no choice but to procure all 5 magazines. Such a task costs time and money. For someone, who is interested in reading about a current political issue, for example, federal funding for education, would want to access only articles related to that topic scattered across multiple magazines. Consequently, such a customer will have to purchase all these magazines even if interest in rest of the contents of these magazines is absent.

In addition, a customer as indicated by the demand for Books on Tape, would be interested in having the magazine article of interest read by someone else, for example during office commute. In addition, if all the articles of interest from multiple magazines were present in one location, the customer need not buy multiple magazines. Moreover, such an arrangement, will allow the customer to use time efficiently by completing the office commute and reading, or in this case hearing, all magazine articles of interest.

In the present invention, a customer can access multiple articles of interest from one or more magazines and receive a collection of articles of interest only. The collection of articles can be in an audible mode or in a readable mode. The preferred embodiment of the present invention is to make a collection of articles from one or more magazines accessible and to provide this collection of magazine articles in audio mode.

To summarize, the novelty of the present invention lies in offering a customer the ability to create his or her own magazine while maximizing the interest factor and also making the newly created magazine available to the customer in alternate modes such as audio mode, if desired. So, the present invention facilitates cost savings for the customer by not requiring the customer to purchase multiple magazines, but to pay only for the desired articles and receive them as a collection of articles or in other words, a personalized magazine in the desired mode.

### BRIEF SUMMARY OF THE INVENTION

In this invention a method of doing business of creating a collection of magazine articles is described. The method involves creating a collection of magazine articles from one or more than one magazine. The source of the articles can be printed magazines or electronic magazines. Further, the collection of articles can be created from articles, unpublished, but intended for publication. The collection of articles can be created in audio or readable mode. The present method of doing business also describes the method of transferring a collection of magazine articles to a customer. The collection of articles can be transferred to a customer using electronic transfer, or by mailing the collection of articles in a suitable storage medium, or the collection of articles in audio mode can be heard online on the internet.

As mentioned earlier, with the advent of technological innovations, people aspire for more efficiency and more goals to achieve. Consequently, people try to complete more tasks in a day than before. However, goal-driven self-imposed higher expectations can result in frustrations such as “but, lately, I haven't had time to read,” or “I can't find time to sit down to read a magazine,” or “I have several unread issues of my favorite magazine on my desk,” or “my schedules are so tight that I don't get time to read even one article,” or “I wish someone could read magazines to me!”

Currently, there are magazines, both printed and electronic, available to readers interested in reading articles in such magazines. Also, there are multiple web sites and organizations that offer some of these magazines in electronic form. These web sites and organizations offer partial or complete content from one magazine in audible or readable modes. However, all articles in all magazines may not be to the liking or of interest to all readers. So, if a reader wanted to read all articles related to a particular field, such as medicine from multiple magazines, the reader, currently, has no choice but to access all those magazines, via a library, or internet, or purchase the required magazines.

The present invention offers improvements over prior art by allowing a collection of articles to be created from one or more magazines. So, essentially, readers interested in multiple articles from multiple magazines can access those articles at one location, a collection of articles. On several occasions, customers who are interested in multiple articles may not have the time to read all of them. The present invention offers a method of doing business of creating a collection of articles from one or more magazines and transferring the collection of articles in audio mode to the customers.

APA released survey results of a consumer study, Audiobook Market Survey: Customer Profile, Usage Patterns, and Experiences. The independent research firm, InfoTrends, interviewed 3,646 U.S. consumers via a web-based survey between May 12 and May 21, 2006. The results indicated that 1 in 4 Americans have listened to an audio book in 2005; audio book sales reach an estimated $871 million; 94.3% of active audio book listeners have not read a printed book in the last 12 months prior to the survey. This survey indicates a trend of increased demand and interest in listening to audio versions of readable content.

The current invention supports the said demand and interest for audio versions and solves two potential customer problems of lack of enough time to read multiple magazines and cost that could be incurred by the customer in having to purchase several magazines to access all articles of interest. So, the customers who are interested in multiple articles from multiple magazines can choose to have a collection of such articles in audio mode recorded in voices of either professional readers or amateur readers.

### BRIEF DESCRIPTION OF DRAWINGS

FIG. 1 shows an overview of present invention.

FIG. 2 shows the detailed overview of the present invention.

FIG. 3a shows customer initiated actions and outcome.

FIG. 3b shows modes of output article collection.

FIG. 4 shows output article creation method to audio mode by readers.

FIG. 5 shows output article creation method to audio mode with software.

FIG. 6 shows output article creation method to non-audio mode.

FIG. 7 shows flow chart of preferred embodiment.

### DESCRIPTION OF THE INVENTION

In this section, a detailed description of the embodiments and drawings is provided. Embodiments described herein are to describe the best modes of practicing the invention currently known to the inventor. It is to be understood that the present invention can be embodied in various alternate forms. It is also to be understood that this invention is not limited to the specific embodiments and methods described herein. Therefore, the specific details disclosed herein are not to be interpreted as limiting, but merely as a representative basis for any aspect of the invention and/or as a representative basis for teaching one skilled in the art to alternately employ the current invention. Also, the terminology used herein is used only for the purpose of describing the specific embodiments of the current invention and is not intended to be limiting in any way.

In this invention, a method of creating a collection of magazine articles is described. In FIG. 1, an overview of the method is shown and identified as 1. Customer 2 in method 1 interacts with article origins 3 via customer initiated action 65 to create a collection of magazine articles 4. The said method can be completely or partially computer-implemented. Additionally, the said method can be completely or partially implemented using the internet.

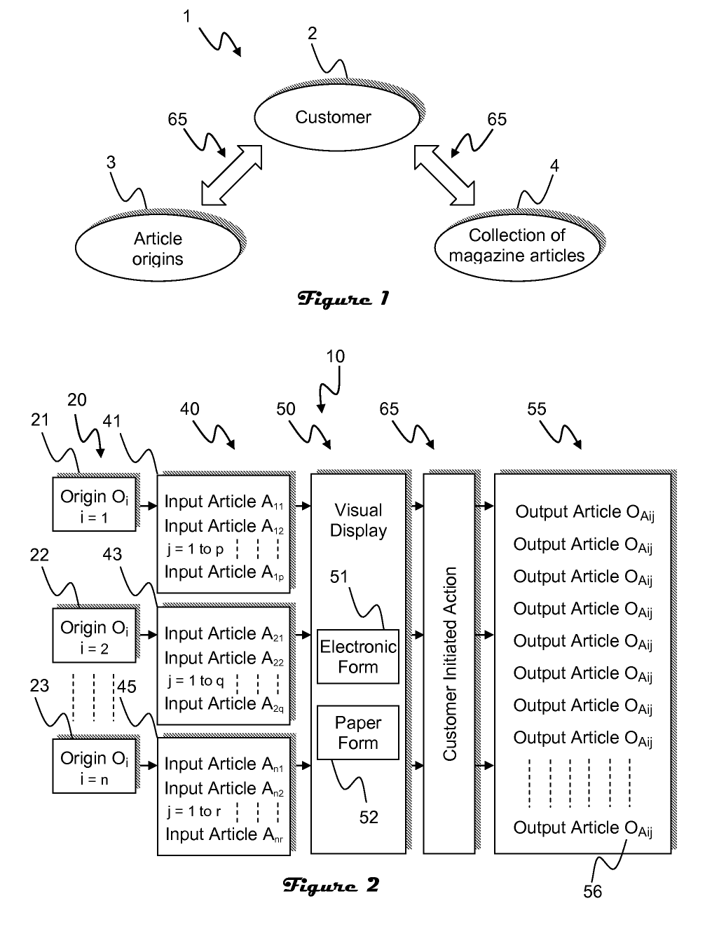

In FIG. 2, a more detailed overview of the method of doing business 10 of the present invention is shown. Input to method 10 comprises of one or more origin titles, Oᵢ constituting origin title list shown as 20, where i can attain any value from 1 through n and n is maximum number of origin titles in origin title list 20. Origin of an origin title 21 can be a printed magazine. Alternately, origin of origin title list 21 can comprise unpublished material intended for publication. Origin title list 20 comprises of input article title list 40. An input article is the original article in its native form. An output article is the input article that has been converted to customer chosen mode.

Input article title list 41 can be associated with origin title Oᵢ (i=1), 21 shown in FIG. 2, Aᵢⱼ, where j can attain a value from 1 through p and p is maximum number of article titles A₁ⱼ. With reference to FIG. 2, subscripts i, j, p, q, and r are integers. Origin title Oᵢ (i=2), 22 in FIG. 2 can comprise one or more input article titles 43, A₂ⱼ where j can attain a value from 1 through q and q is maximum number of article titles A₂ⱼ. Similarly, origin Oᵢ (i=n), 23 in FIG. 2 can comprise input article title list 45, comprising one or more input article titles Aₙⱼ where j can attain a value from 1 through r and r is maximum number of article titles Aₙⱼ.

Input article title list 40 from origin title list 20 is presented to customer in method of doing business 10 of current invention using a visual display 50. Visual display can be in electronic form 51, such as a computer screen where input article title list 40 is displayed on a computer screen. Visual display can be in paper form 52, such as a printed paper, where input article title list 40 is displayed on a printed paper. A list of titles of articles from multiple magazines can be sent to customer on a paper for customer review. Such a list of titles of articles on paper can be mailed to customer. Alternately, list of titles of articles can be sent to customer via e-mail and customer can print the list on paper and review it. Preferred embodiment is to present a visual display on a web site viewed on a computer screen that is connected to the internet.

After reviewing input article title list 40 via visual display 50, customer initiated action 65 can result in desired output article collection 55. Output article collection 55 can comprise of output article O_{Aij} shown as 56 in FIG. 2. Output article collection O_{Aij} is in desired mode, created from input article title list 40, for transfer to customer. In the preferred embodiment, output article collection 55 is presented to the customer on a web site on the internet.

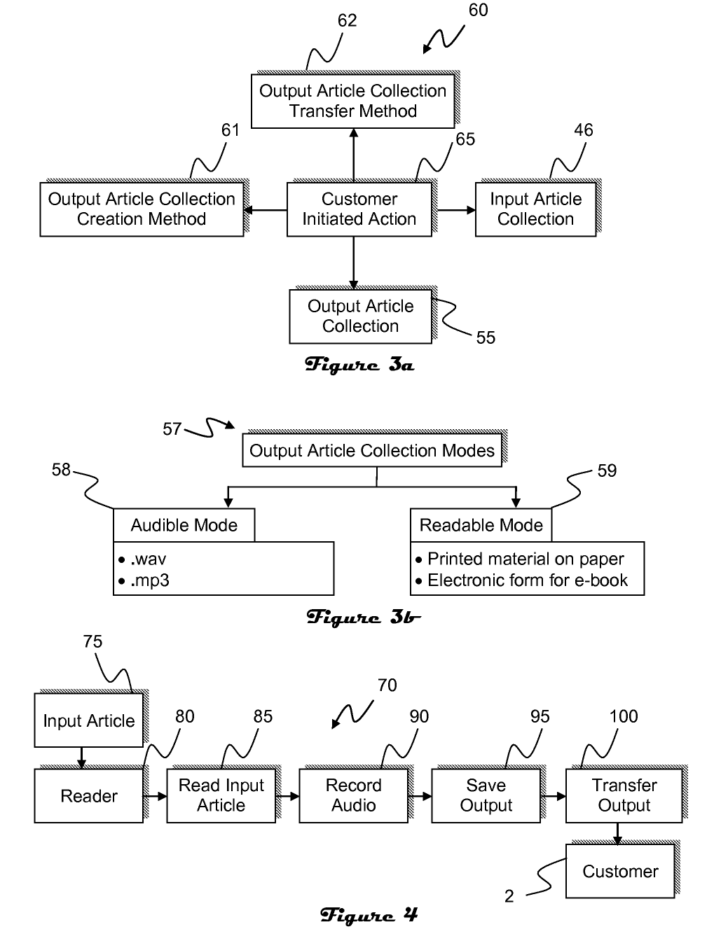

With reference to FIG. 3a, customer initiated action 65 and outcome of customer initiated action 65 are shown in 60. Customer initiated actions 65 include interaction with origin title list 20 to create input article collection 46. Input article collection 46 is a collection of input articles associated with input article titles of input article title list 40 chosen by customer for transfer. Another customer initiated action 65 results in the creation of output article collection 55 from input article collection 46. With reference to FIG. 3b, customer can choose at least one of output article collection modes 57. Output article collection 55 can be in audible mode 58 or in readable mode 59. Output article collection 55 in audible mode can be an audio file in a suitable format such as .wav or .mp3 that can be used in an audio device for playback. A suitable audio device can be a cassette player or CD player or mp3 player. Output article collection 55 in readable mode can be printed material on a paper or in electronic form that can be read using an e-book reader.

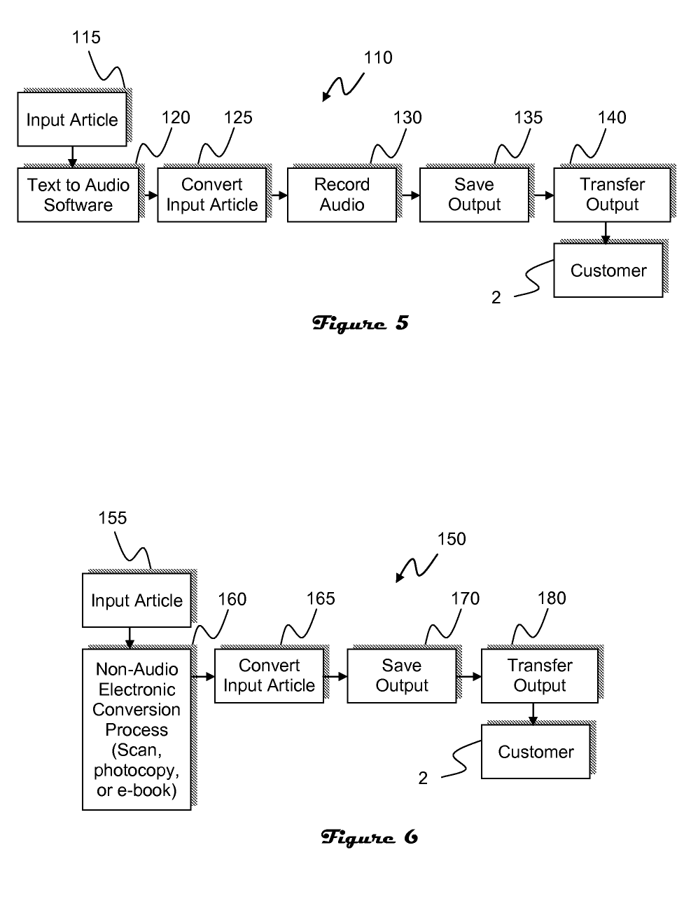

Further customer initiated actions 65 include selection of output article creation method 61 and selection of output article transfer method 62. Output article creation methods are described in more detail in FIG. 4, FIG. 5, and FIG. 6.

Output article transfer method 62 can comprise e-mail, download, podcast, streaming, online play, online display, mailing output article collection in a suitable medium. A suitable medium can include a removable memory storage device such as and not limited to a CD, DVD, and flash drive. Output article transfer method 62 can be e-mail wherein output article collection 55 is e-mailed to customer 2. Output article transfer method 62 can be download wherein output article collection 55 is available on the internet from a web site and the customer can download or electronically transfer output article collection 55. Alternately, output article collection 55 can be podcast or streamed from a web site on the internet. Further, an alternate output article collection transfer method 62 can be playback of output article collection 55 in audio mode on a web site. Yet another output article collection transfer method 62 can be online display of output article collection 55 on a web site viewed on a computer screen associated with a computer that is connected to internet.

Referring to FIG. 4, an embodiment of output article collection creation method 61 of FIG. 3a, output article collection transfer method 70 is shown. In this embodiment, an input article 75 is read by a reader 80, either a professional reader or an amateur reader. As the input article 75 is read by a reader 80, the voice of the reader is recorded [90], and associated audio is saved [95] in a suitable format such as .wav or .mp3. As described earlier, a customer initiated action can transfer [100] output article collection 55 to customer 2.

Referring to FIG. 5, an embodiment of output article collection creation method 61 of FIG. 3a, output article collection transfer method 110 is shown. In this embodiment, an input article 115 is input into text to audio software 120. As input article 115 is processed by text to audio software 120, input article 115 is converted [125] to audio mode, and associated audio is recorded [130] in a suitable format such as .wav or .mp3 and output article is saved [135]. As described earlier, a customer initiated action can transfer [140] output article collection 55 to customer 2.

Referring to FIG. 6, an embodiment of output article collection creation method 61 of FIG. 3a, output article collection transfer method 150 is shown. In this embodiment, an input article 155 is processed by electronic reproduction equipment such as a scanner, a photocopier, or a combination of software and electronic reproduction equipment for e-book, and is converted to readable mode [165], and associated output article is saved [170]. As described earlier, a customer initiated action can transfer [1 80] output article collection 55 to customer 2.

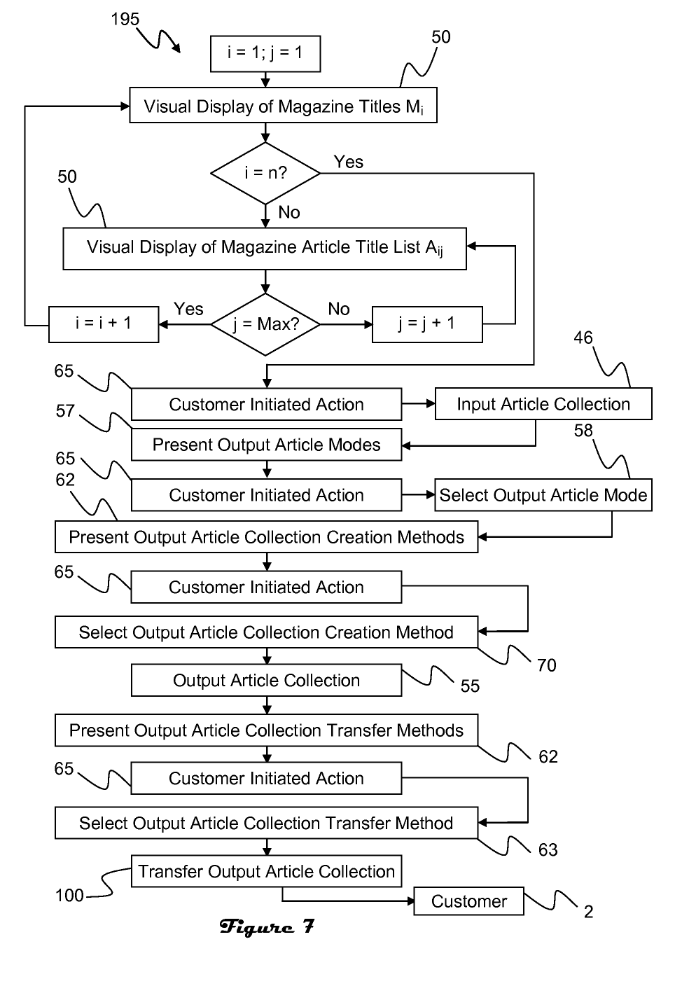

A preferred embodiment, 195 of method of doing business 1 of current invention is shown in FIG. 7. Visual display [50] of available magazines titles is presented on a web site on the internet. Further visual display [50] of associated magazine article title list is presented on a web site on the internet. A customer initiated action 65 results in an input article collection 46. A customer initiated action can be selection of articles of interest by the customer either by entering reference numbers associated with the titles of article of interest or by clicking on check boxes associated with the titles of articles of interest using a pointing device such as a computer mouse.

Customer has the option of selecting the mode 57 of the desired output article collection 55. In the preferred embodiment the desired output article mode 58 is audio mode. Further, customer is presented output article collection creation methods 62. In preferred embodiment, a customer initiated action 65 results in selection of output article collection creation method 70. Consequently, using the chosen output article collection creation method 70, output article collection 55 is created. Customer is presented output article collection transfer methods 62 to transfer desired output article collection to customer. A customer initiated action 65 results in selection of output article collection transfer method 63 such as download from web site. Consequently, output article collection is transferred [100] to customer using the chosen output article collection transfer method 63.

What is claimed is:

1. Method of creating a collection of magazine articles, wherein said article comprises alphanumeric content, wherein said collection comprises at least one article associated with at least one article origin, wherein said article origin comprises published source, wherein said article origin can further comprise unpublished source, and transferring said collection of articles to customer; method comprising,
presentation to customer origin title list comprising first origin title;
presentation to customer origin title list wherein said origin title list can further comprise second origin title;
presentation to customer an article title list comprising at least one article title associated with said first article origin title;
presentation to customer said article title list, wherein said article title list further can comprise an article associated with said second article origin title;
customer initiated action resulting in creation of an article collection comprising at least one article associated with article title, said article tile associated with said article title list;
customer initiated transfer action resulting in transfer of said article collection to customer.

2. Method of doing business of claim 1 wherein presentation comprises visual display in electronic form.

3. Method of doing business of claim 1 wherein presentation comprises visual display on paper.

4. Method of doing business of claim 1 wherein article can comprise alphanumeric content in readable mode.

5. Method of doing business of claim 1 wherein article can comprise alphanumeric content in audible mode.

6. Method of doing business of claim 1 wherein published source comprises printed magazine.

7. Method of doing business of claim 1 wherein published source comprises electronic magazine.

8. Method of doing business of claim 1 wherein unpublished source comprises articles intended for publication in a magazine.

9. Method of creating a collection of magazine articles wherein said article comprises alphanumeric content, wherein said collection comprises at least one output article associated with at least one input article origin, wherein said input article origin comprises published magazine, wherein said input article origin can further comprise unpublished source, and transferring said collection of articles to customer; method comprising,
presentation to customer an input article origin title list comprising a first input article origin title;
presentation to customer an input article origin title list wherein said input article origin title list can further comprise a second input article origin title;
presentation to customer an input article title list comprising at least one input article title associated with said first input article origin title;
presentation to customer said input article title list, wherein said input article title list can further comprise an input article associated with said second input article origin title;
customer initiated action resulting in an input article collection comprising at least one input article associated with input article title, said input article title associated with said input article title list;
customer initiated action resulting in selection of output article creation method;
customer initiated action resulting in an output article collection comprising at least one output article associated with an input article, said input article associated with said input article collection;
customer initiated action resulting in selection of output article transfer method;
customer initiated action resulting in transfer of output article collection to customer;

10. Method of doing business of claim 9 wherein presentation comprises visual display in electronic form.

11. Method of doing business of claim 9 wherein presentation comprises visual display on paper.

12. Method of doing business of claim 9 wherein published source comprises printed magazine.

13. Method of doing business of claim 9 wherein published source comprises electronic magazine.

14. Method of doing business of claim 9 wherein unpublished source comprises articles intended for publication in a magazine.

15. Method of doing business of claim 9 wherein output article can comprise alphanumeric content in audible mode

16. Method of doing business of claim 9 wherein output article can comprise alphanumeric content in readable mode

17. Method of doing business of claim 9 wherein output article creation method can comprise voice recording of professional readers reading said input article

18. Method of doing business of claim 9 wherein output article creation method can comprise voice recording of amateur readers reading said input article

19. Method of doing business of claim 9 wherein output article creation method can comprise conversion of said input article to said output article in audible mode using a suitable software program

20. Method of doing business of claim 9 wherein output article creation method can comprise reproduction of said input article to said output article using an electronic conversion process.

21. Method of doing business of claim 9 wherein output article transfer method can comprise e-mail.

22. Method of doing business of claim 9 wherein output article transfer method can comprise mailing said output article collection, said output article collection stored in suitable storage medium.

23. Method of doing business of claim 9 wherein output article transfer method can comprise electronic data transfer.

24. Method of doing business of claim 9 wherein output article transfer method can comprise playback on the internet.

25. Method of creating a collection of magazine articles wherein said article comprises alphanumeric content, wherein said collection comprises at least one output article associated with at least one input article origin, wherein said input article origin comprises printed magazine, and transferring said collection of articles to customer; method comprising,
presentation to customer an input article origin title list comprising a first input article origin title;
presentation to customer an input article origin title list wherein said input article origin title list can further comprise a second input article origin title;
presentation to customer an input article title list comprising at least one input article title associated with said first input article origin title;
presentation to customer said input article title list, wherein said input article title list can further comprise an input article associated with said second input article origin title;
customer initiated action resulting in an input article collection comprising at least one input article associated with input article title, said input article title associated with said input article title list;
customer initiated action resulting in selection of output article creation method;
customer initiated action resulting in an output article collection comprising at least one output article associated with an input article, said input article associated with said input article collection;
customer initiated action resulting in selection of output article transfer method;
customer initiated action resulting in transfer of output article collection to customer.
